(19) United States
(12) Patent Application Publication
(10) Pub. No.: US 2010/0154838 A1
(43) Pub. Date: Jun. 24, 2010

(54) METHOD FOR REDUCING ADHESION OF DUST TO A FAN, AND HOUSING DEVICE HAVING A DUST REMOVING UNIT

(76) Inventors: Zhi-Hong Shih, Taipei Hsien (TW); Ming-Chih Chen, Taipei Hsien (TW)

Correspondence Address: NIXON & VANDERHYE, PC, 901 NORTH GLEBE ROAD, 11TH FLOOR, ARLINGTON, VA, 22203, US

(21) Appl. No.: 12/606,412

(22) Filed: Oct. 27, 2009

(30) Foreign Application Priority Data
Dec. 22, 2008 (TW) 097150052

(51) Int. Cl. B08B 5/00

(52) U.S. Cl. 134/34; 134/109

(57) ABSTRACT

A housing device includes a housing, a fan, and a dust removing unit. The housing defines an air passage. The fan is provided in the housing, and is located at a distal end of the air passage for exhausting air from the housing. The dust removing unit includes an airflow interfering member and an adhering member. The airflow interfering member is provided within the housing, and is located upstream of the fan for interfering with flow of air toward the fan. The adhering member is provided downstream of the airflow interfering member and upstream of the fan for adhering dust entrained in the air flowing toward the fan. The dust falling down onto the adhering member when the airflow is interfered by the airflow interfering member.

### CROSS-REFERENCE TO RELATED APPLICATION

This application claims priority of Taiwanese Application No. 097150052, filed on Dec. 22, 2008.

### BACKGROUND OF THE INVENTION

1. Field of the Invention

The invention relates to a dust removing unit, more particularly to a housing device having a dust removing unit capable of reducing adhesion of dust to a fan of the housing device.

2. Description of the Related Art

Since processors are operating at increasingly higher speeds, current notebook computers generate more and more heat during operation. If the heat cannot be dissipated quickly, stability of system operation will be seriously affected, and undesirable crashing may even occur as a result of overheating. A common method of heat dissipation currently used in the industry is to utilize a heat-dissipating module (a heat pipe and heat-dissipating fins) in conjunction with a fan to effect forced convection for heat dissipation purposes.

Referring to FIG. 1, when a fan 11 in a housing 12 operates, air from the outside is drawn into an air passage 13 defined by a top wall 121 and a bottom wall 122 of the housing 12 via air inlets 123, and the air flows along the air passage 13 in a direction indicated by the arrows to be exhausted through the fan 11.

However, when the outside air is drawn into the housing 12, dust entrained in the drawn air will be carried into the air passage 13, and the dust will adhere to the fan 11. After a period of time, the fan 11 will have a considerable amount of dust accumulated thereon, which will adversely affect the efficiency of the fan 11 in exhausting hot air from the housing 12.

### SUMMARY OF THE INVENTION

Therefore, an object of the invention is to provide a method for reducing adhesion of dust to a fan.

Another object of the invention is to provide a housing device having a dust removing unit capable of reducing adhesion of dust to a fan.

Accordingly, the method for reducing adhesion of dust to a fan of this invention comprises:

(A) providing an airflow interfering member upstream of a fan for interfering with flow of air toward the fan; and

(B) providing an adhering member downstream of the airflow interfering member and upstream of the fan for adhering dust entrained in the air flowing toward the fan, the dust falling down onto the adhering member when the flow of air is interfered by the airflow interfering member.

Preferably, a double-sided adhesive tape is used to serve as the adhering member in step (B).

Preferably, in step (A), a sheet is used to serve as the airflow interfering member, and the airflow interfering member is disposed in an inclined manner.

The housing device of this invention includes a housing, a fan, and a dust removing unit. The housing defines an air passage. The fan is provided in the housing, and is located at a distal end of the air passage for exhausting air from the housing. The dust removing unit includes an airflow interfering member and an adhering member. The airflow interfering member is provided in the housing, and is located upstream of the fan for interfering with flow of air toward the fan. The adhering member is provided downstream of the airflow interfering member and upstream of the fan for adhering dust entrained in the air flowing toward the fan. The dust falls down onto the adhering member when the flow of air is interfered by the airflow interfering member.

Preferably, the airflow interfering member has an inclined face that is inclined along a direction of the flow of air in the air passage.

Preferably, the airflow interfering member is a sheet disposed on an inner wall surface of the housing in an inclined manner. The inclined face is a surface of the sheet.

Preferably, the adhering member has a side facing the air passage and having an adhering property.

Preferably, the adhering member is a double-sided adhesive tape.

In an embodiment of this invention, the housing includes a housing body and a movable piece. The housing body has an opening. The movable piece is detachably coupled to the housing body and covers the opening. The adhering member is connected to an inner wall face of the movable piece.

In another embodiment of this invention, the housing includes a housing body and a movable piece. The housing body has an opening. The movable piece is detachably coupled to the housing body and covers the opening. The airflow interfering member and the adhering member are connected to an inner wall face of the movable piece. Preferably, the airflow interfering member is integrally formed with the movable piece.

The advantageous effect of this invention resides in that, by virtue of the arrangement of the adhering member upstream of the fan and the airflow interfering member upstream of the adhering member, air flowing past the airflow interfering member is interfered thereby so that dust entrained in the air falls down onto the adhering member and is adhered thereto, thereby reducing adhesion of dust to the fan.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary schematic view to illustrate the assembly relationship between a housing and a fan of the prior art;

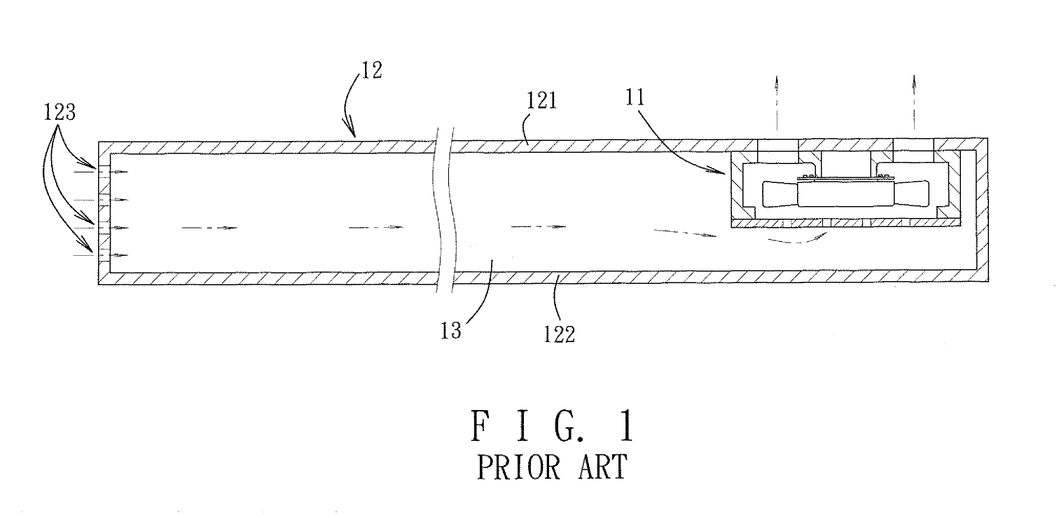

FIG. 2 is a fragmentary schematic sectional view to illustrate the first preferred embodiment of a housing device having a dust removing unit according to the invention;

FIG. 3 is a fragmentary schematic sectional view of the second preferred embodiment of a housing device having a dust removing unit according to the invention; and

FIG. 4 is a flowchart to illustrate a method for reducing adhesion of dust to a fan according to the invention.

### DETAILED DESCRIPTION OF THE PREFERRED EMBODIMENTS

Before the present invention is described in greater detail, it should be noted that like elements are denoted by the same reference numerals throughout the disclosure.

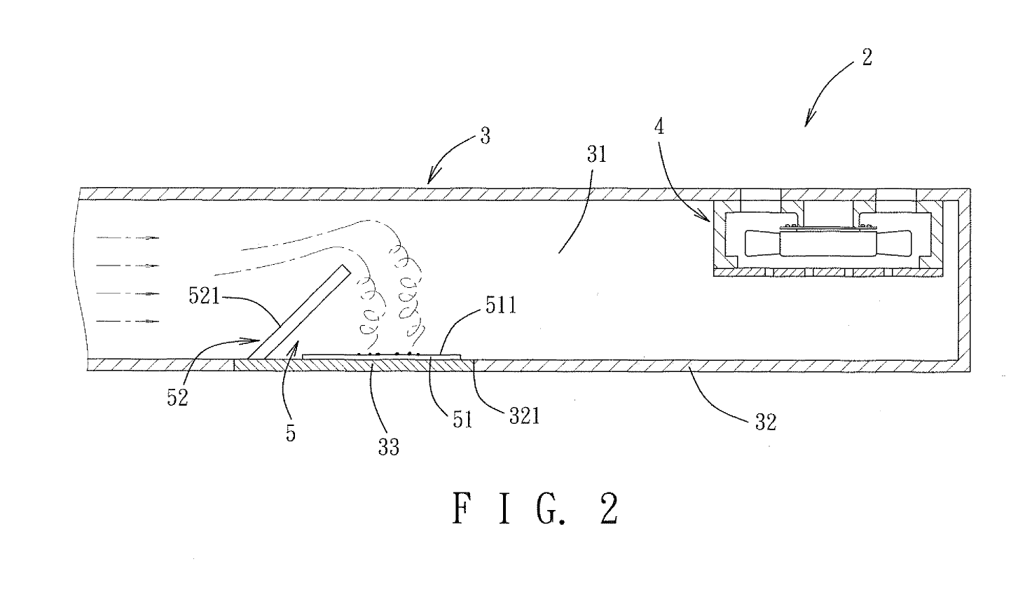

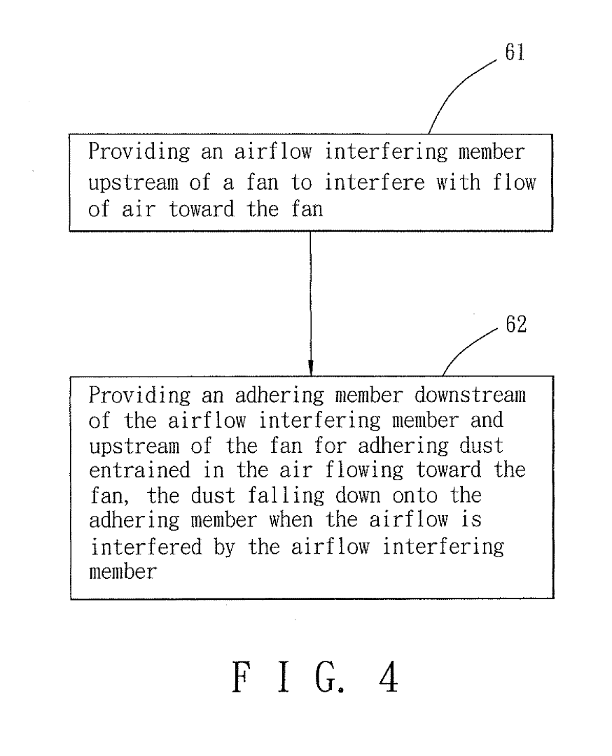

Referring to FIGS. 2 and 4, the first preferred embodiment of a housing device 2 according to the invention is shown to comprise a housing 3, a fan 4, and a dust removing unit 5.

The housing 3 defines an air passage 31. The fan 4 is disposed in the housing 3, and is located at a distal end of the air passage 31 for exhausting air from the housing 3 to the outside. The fan 4 in this embodiment is provided on a top wall of the housing 3, but may be arranged at any other position in other embodiments of the invention, so long as the fan 4 is located at the distal end of the air passage 31 and can cause flowing movement of the air within the air passage 31.

The dust removing unit 5 includes an airflow interfering member 52 and an adhering member 51. The airflow interfering member 52 has an inclined face 521.

The method for reducing adhesion of dust to a fan according to the invention comprises the following steps.

In step 61, the airflow interfering member 52 is provided on an inner wall surface of the housing 3, and is located upstream of the fan 4 so as to interfere with flow of air toward the fan 4. In this embodiment, a sheet is used to serve as the airflow interfering member 52, and the sheet is arranged in an inclined manner. The inclined face 521 is a side surface of the sheet.

In step 62, the adhering member 51 is provided on the inner wall surface of the housing 3, and is located in the air passage 31 downstream of the airflow interfering member 52 and upstream of the fan 4. The adhering member 51 is used to adhere dust, and has a side face 511 facing the air passage 31 and having an adhering property so that dust can adhere thereto. In this embodiment, the adhering member 51 is a double-sided adhesive tape adhered to the inner wall surface of the housing 3, but is not limited thereto in other embodiments of the invention.

When the fan 4 operates, a flow of air toward the fan 4 will be created in the air passage 31 due to the exhausting action of the fan 4. When the air flows past the airflow interfering member 52, the configuration of the inclined face 521 of the airflow interfering member 52 will have an interfering effect on the air flowing past the same, so that a turbulence is created at a top end of the airflow interfering member 52. Since such turbulence will slow down the speed of the air flowing toward the fan 4, dust entrained in the airflow will fall by virtue of gravity as the airflow slows down, and will adhere to the side face 511 of the adhering member 51. Therefore, the amount of dust entrained in the air flowing toward the fan 4, hence the amount of dust that will adhere to the fan 4, can be reduced to thereby alleviate the problem of accumulation of dust on the fan 4, so that efficiency of the exhausting action of the fan 4 will not be adversely affected.

It is noted that, in consideration of the fact that the adhering member 51 will have a lot of dust adhered thereto after a period of time and eventually has to be replaced, the housing 3 in this embodiment includes a housing body 32 and a movable piece 33. The housing body 32 has an opening 321. The movable piece 33 is detachably coupled to the housing body 32, and covers the opening 321. The airflow interfering member 52 and the adhering member 51 are connected to an inner wail face of the movable piece 33. From time to time, the movable piece 33 can be removed from the housing body 32 for replacement of the adhering member 51. Furthermore, the airflow interfering member 52 may be configured to be integrally formed with the movable piece 33.

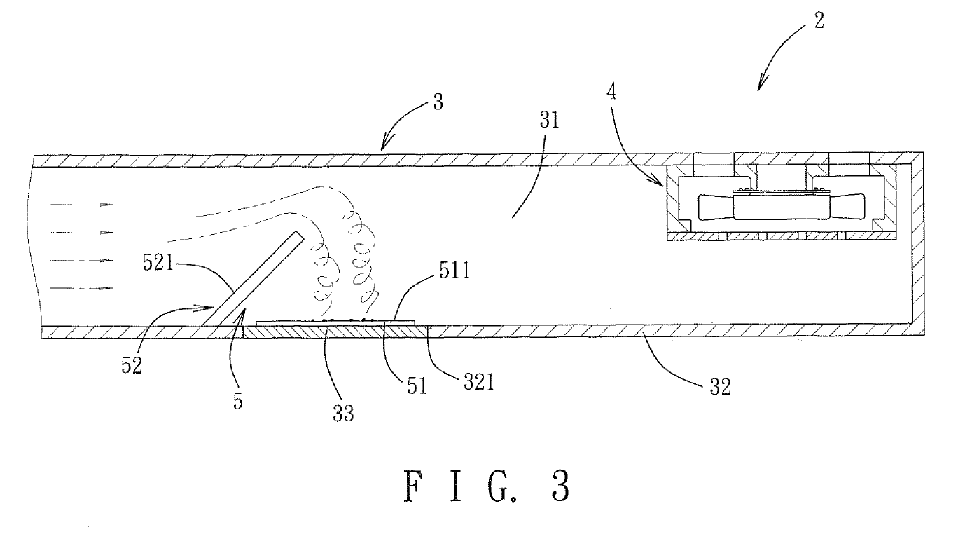

FIG. 3 illustrates the second preferred embodiment of the housing device 2 according to the invention. The second preferred embodiment differs from the first preferred embodiment mainly in the position of the airflow interfering member 52 of the dust removing unit 5.

In this embodiment, the airflow interfering member 52 is connected to an inner wall surface of the housing body 32, and only the adhering member 51 is provided on the inner wall face of the movable piece 33. Since the working principle of the second preferred embodiment is the same as that of the first preferred embodiment, it will not be repeated herein for the sake of brevity.

In sum, the invention utilizes the airflow interfering member 52 to interfere with the flow of air toward the fan 4 so that dust entrained in the air falls down onto the adhering member 51 and is adhered thereto, thereby reducing the amount of dust carried in the air flowing toward the fan 4, and hence the amount of dust that will adhere to the fan 4.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for reducing adhesion of dust to a fan, comprising:
(A) providing an airflow interfering member upstream of the fan for interfering with flow of air toward the fan; and
(B) providing an adhering member downstream of the airflow interfering member and upstream of the fan for adhering dust entrained in the air flowing toward the fan, the dust falling down onto the adhering member when the flow of air is interfered by the airflow interfering member.

2. The method for reducing adhesion of dust to a fan of claim 1, wherein a double-sided adhesive tape is used to serve as the adhering member in step (B).

3. The method for reducing adhesion of dust to a fan of claim 1, wherein a sheet is used to serve as the airflow interfering member in step (A).

4. The method for reducing adhesion of dust to a fan of claim 3, wherein the airflow interfering member is disposed in an inclined manner in step (A).

5. A housing device comprising:
a housing defining an air passage;
a fan disposed in said housing and located at a distal end of said air passage for exhausting air from said housing; and
a dust removing unit, which includes:
an airflow interfering member provided in said housing and located upstream of said fan for interfering with flow of air toward said fan; and
an adhering member provided downstream of said airflow interfering member and upstream of the fan for adhering dust entrained in the air flowing toward said fan, the dust falling down onto said adhering member when the flow of air is interfered by said airflow interfering member.

6. The housing device of claim 5, wherein said airflow interfering member has an inclined face that is inclined along a direction of the flow of air in said air passage.

7. The housing device of claim 6, wherein said airflow interfering member is a sheet disposed on an inner wall surface of said housing in an inclined manner, said inclined face being a surface of said sheet.

8. The housing device of claim 5, wherein said adhering member has a side facing said air passage and having an adhering property.

9. The housing device of claim 8, wherein said adhering member is a double-sided adhesive tape.

10. The housing device of claim 5, wherein said housing includes a housing body and a movable piece, said housing body having an opening, said movable piece being detachably coupled to said housing body and covering said opening, said adhering member being connected to an inner wall face of said movable piece.

11. The housing device of claim 8, wherein said housing includes a housing body and a movable piece, said housing body having an opening, said movable piece being detachably coupled to said housing body and covering said opening, said adhering member being connected to an inner wall face of said movable piece.

12. The housing device of claim 5, wherein said housing includes a housing body and a movable piece, said housing body having an opening, said movable piece being detachably coupled to said housing body and covering said opening, said airflow interfering member and said adhering member being connected to an inner wall face of said movable piece.

13. The housing device of claim 12, wherein said airflow interfering member is integrally formed with said movable piece.

14. The housing device of claim 8, wherein said housing includes a housing body and a movable piece, said housing body having an opening, said movable piece being detachably coupled to said housing body and covering said opening, said airflow interfering member and said adhering member being connected to an inner wall face said movable piece.

15. The housing device of claim 14, wherein said airflow interfering member is integrally formed with said movable piece.
